(19) United States
(12) Patent Application Publication
(10) Pub. No.: US 2020/0367454 A1
(43) Pub. Date: Nov. 26, 2020

(54) METHOD AND APPARATUS FOR GROWING VEGETATION

(71) Applicant: JDSCAP Synergistics, LLC, Sheridan, WY (US)

(72) Inventor: Jonathan D. PARTLOW, Fishers, IN (US)

(73) Assignee: JDSCAP Synergistics, LLC, Sheridan, WY (US)

(21) Appl. No.: 16/635,242

(22) PCT Filed: Aug. 1, 2018
(86) PCT No.: PCT/US2018/044818

§ 371 Date: Jan. 30, 2020

Related U.S. Application Data
(60) Provisional application No. 62/540,243, filed on Aug. 2, 2017.

(51) Int. Cl. A01G 31/02; A01G 22/05

(52) U.S. Cl. CPC A01G 31/02; A01G 22/05

(57) ABSTRACT

A method of growing a single plant in a single growth chamber such that the plant may be continously harvested with the replacement of a nutrient media in the chamber. The method of growing the single plant comprises the step of positioning an immature portion of a plant in a growth pod. The method also comprises positioning the growth pod in an aperture of a cap comprising a material that prevents the transmission of light through the cap. The method also comprises supporting the cap on a housing comprising a material that prevents the transmission of light through the housing. The method further comprises placing a liquid nutrient solution in the housing, such the upper surface of the liquid nutrient solution is lower than the lower surface of the growth pod.

### CROSS-REFERENCE TO RELATED APPLICATIONS

This application claims priority under 35 U.S.C. § 119(e) to U.S. Provisional Application Ser. No. 62/540,243 filed on Aug. 2, 2017, the entire disclosure of which is incorporated herein by reference.

### TECHNICAL FIELD

The present disclosure is related to a method and apparatus for growing vegetation hydroponically. More specifically, the present application is related to a method and apparatus for applying a method of using mixed media micro growing approach in individual micro growth chambers.

### BACKGROUND

Hydroponic agriculture is a form hydroculture where plants or other organisms are grown in a water-based nutrient solution. In historical approaches, the nutrient solution must be carefully monitored and controlled to maintain the optimum arrangement for oxygenation of the root structure and density of the nutrients in the solution. In general, hydroponic systems require active management and control of various parameters that impact the growth rate of the hydroponically grown organisms. This includes irrigation, fogging of plant roots, oxygenation or other methods that require motive forces to effect the feeding of the organisms.

Traditional hydroponic methods are susceptible to various challenges, including the lack of power sources for active feeding and oxygenation and the need for careful controls of the nutrients fed to the organisms. These active control techniques limit the applicability of hydroponic growing techniques on a large scale or in remote areas. On the other hand, hydroponic growth is recognized as a very effective approach for the rapid growth achieved in a relatively small space.

Traditional passive hydroponic systems require close monitoring of and are limited to a single growth cycle for short growth cycle plants, such a lettuce, for example. Once harvested, the plants are removed from the system and a new growth is started.

While the promise of hydroponics has not been realized in the current environment, worldwide population growth and the consequential rise in population density is increasing the incidence of food insecurity around the world. Even in urban areas, the problem of a lack of access to healthy, natural, produce is evidenced by the presence of food deserts, which are locations in urban areas where food staples are not readily accessible to the populace without significant travel burdens. Thus, there is a need for a simple, relatively low cost, relatively low maintenance, non-powered apparatus for growing edible organisms that can be implemented in locales throughout the world.

### SUMMARY

The present disclosure includes one or more of the features recited in the appended claims and/or the following features which, alone or in any combination, may comprise patentable subject matter.

According to a first aspect of the present disclosure, a method of growing a vegetative plant comprises the step of positioning an immature portion of a plant in a growth pod. The method also comprises positioning the growth pod in an aperture of a cap comprising a material that prevents the transmission of light through the cap. The method also comprises supporting the cap on a housing comprising a material that prevents the transmission of light through the housing. The method further comprises placing a liquid nutrient solution in the housing, such the upper surface of the liquid nutrient solution is lower than the lower surface of the growth pod. The method still further comprises subjecting the plant to light. The method yet further comprises monitoring the growth of the plant until growth sufficient for harvesting is achieved. The method yet still further includes harvesting portions of the plant on an intermittent basis. The method still yet further includes reapplying nutrient solution to provide continuous growth of the plant such that the plant continues to grow and provide multiple yields.

In some embodiments, the method may yet further comprise adding a liquid impervious liner to the housing prior to placing the liquid nutrient solution in the housing such that the housing supports the liner and the liner retains the liquid nutrient solution.

In some embodiments, the method may yet further comprise positioning the liquid nutrient solution such that the concentration of the nutrients vary through the depth of the nutrient solution.

In some embodiments, the method may yet further comprise growth of a portion of the root structure of the plant to be directly submersed in the liquid nutrient solution.

In some embodiments, the method may yet further comprise a portion of the root structure growing to extend between the bottom of the growth pod and the top surface of the nutrient solution to be exposed to air within the chamber.

In some embodiments, the method may yet further comprise a portion of the root structure of the plant being exposed to air within the chamber to take oxygen from the air within the chamber.

In some embodiments, the method may yet further comprise a portion of the root structure of the plant being exposed to air within the chamber to take in nutrients that are positioned in the air through evaporation of the solution.

In some embodiments, the method may yet further comprise intermittently subjecting the plant to light.

In some embodiments, the method may yet further comprise subjecting the plant to temperatures in excess of 100° Fahrenheit for extended periods.

In some embodiments, the method may yet further comprise monitoring the growing conditions of the plant.

In some embodiments, the method may yet further comprise varying the growing conditions to account for the type of plant.

In some embodiments, the method may yet further comprise controlling the concentration of nutrients by nutrient retention beads positioned in the chamber.

In some embodiments, the method may yet further comprise utilizing a plant that is a fruit-bearing plant.

According to another aspect of the present disclosure, a chamber for growing an organism comprises an opaque housing, a cap supported on the housing, the cover having an aperture defined therein, a growth pod supported from the cap, the growth pod configured to support growth of an organism, and a liquid nutrient solution positioned in the housing, the liquid nutrient solution having an upper surface that is lower than the lower surface of the growth pod.

In some embodiments, the organism may have a root structure that extends below the cap and foliage that extends upwardly from the cap.

In some embodiments, the chamber may further comprise a liquid impervious liner.

In some embodiments, the nutrient solution may include nutrient densities that vary through the depth of the nutrient solution.

In some embodiments, the organism may be fed through the direct submersion of a portion of the organism in the liquid nutrient solution.

In some embodiments, a portion of the organism may extend between the bottom of the pod and the top surface of the nutrient solution to be exposed to air within the chamber.

In some embodiments, a portion of the organism that is exposed to air within the chamber up may take oxygen from the air within the chamber.

In some embodiments, a portion of the organism that is exposed to air within the chamber may up take nutrients through evaporation of the solution.

In some embodiments, the chamber may include a housing that has been repurposed from waste products.

According to another aspect of the present disclosure, a method of growing an organism comprises using the structure of any combination of embodiments of the previous aspect of the disclosure and wherein the method comprises placing an immature organism in a growing media in the pod and allowing the immature organism to mature by consuming the nutrient solution.

In some embodiments, the method further may further comprise replacing consumed nutrient solution to sustain ongoing growth of the organism.

Additional features, which alone or in combination with any other feature(s), such as those listed above and/or those listed in the claims, can comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a perspective view of a growing chamber supporting a growing organism with portions interior to the chamber being illustrated by cutting away a portion of a housing of the chamber; and

FIGS. 2-4 are similar to FIG. 1, each of FIGS. 2-4 showing different stages of growth and levels of a nutrient solution in the chamber.

### DETAILED DESCRIPTION

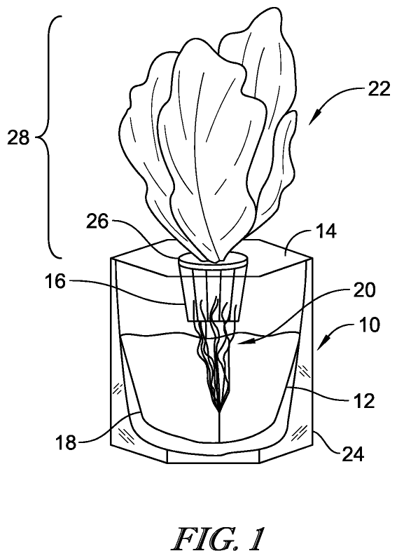

Referring to FIG. 1, the present disclosure includes a method of use of a single chamber 10 configured to contain a hydrating fluid 12 that includes a nutrient solution mix, and a chamber cap 14 with a single growth pod 16 per chamber 10 that contains the hydrating fluid 12 with the nutrient mix. The chamber 10 is lined with a moisture impervious liner 18 such that the hydrating fluid 12 is suspended in the moisture impervious liner 18 and accessible to the root system 20 of a vegetative organism 22. The hydrating fluid 12 delivers a nutrient solution mixture that has a predetermined nutrient ratio. In some embodiments, the hydrating fluid 12 may include layers of nutrient solution ratios separated by density or by solution retention beads or by any other means that suspends the nutrients in a fashion that allows the roots 20 access to appropriate nutrients via the hydrating fluid 12. In other embodiments, the chamber 10 may support a mixed media and hydrating fluid and nutrient solution mix. The embodiment of FIG. 1 is a single chamber 10 that contains a singular growth pod 16. As will be discussed in further detail below, other embodiments may include a plurality of growth pods 16 in an alternative chamber 10. In the embodiment of FIG. 1, the chamber 10 includes a housing 24 that is formed of a corrugated cardboard material. In the illustrative embodiment, the housing 24 is opaque. In other embodiments, the housing may be semi-opaque, but sufficiently filtering light to inhibit the growth of algae inside of the chamber 10. In other embodiments, the housing 24 of the chamber 10 may be entirely impervious to liquids and the liner 18 may be omitted. The below pod 16 portion 20 of the plant 22 is provided all of the nutrients, air and moisture needed for growth from within the chamber 10 and through the growth media 12 within the chamber 10.

The chamber cap 14 includes a singular aperture 26 through which a singular suspended growth pod 16 is supported when inserted into the cap 14. In the illustrative embodiment, the cap 14 is opaque. In other embodiments, the cap 14 may be semi-opaque, but sufficiently filtering light to inhibit the growth of algae inside of the chamber 10. In other embodiments, the growth pod 16 may be integrated into the cap 14. In still other embodiments, the pod 16 may be secured to the cap 14 by mechanical, adhesive, friction or other means.

The cap 14 supports the growth pod 16, provides for the uppermost barrier layer of the air moisture cavity within the chamber 10, supports the weight of the growing plant 22 and stops visible light from entering the chamber 10. It should be understood that the vegetative organism 22 may be a plant or, in some embodiments, may be a fungi or other organism suitable for growth using a nutrient dense fluid 12.

In various embodiments, growth pods 16 can have open tops, semi-closed tops with an opening to allow for the above chamber 10 portion of the plant or fungi to grow or closed tops with enough volume for the plant or fungi to grow within the enclosed top and a plurality of holes in the side walls and bottom. In another embodiment a growth pod 16 may comprise a membrane that allows penetration of the below pod 16 growing portion 20 (e.g. root structure) of the plant 22 or fungi to extend into the nutrient solution 12 or other mixed media that provides for adequate air/moisture exchange. The growth pod 16 may be of any shape or depth as appropriate to allow for and promote the growth of the below growth pod portion 20 of the growing plant 22 or fungi.

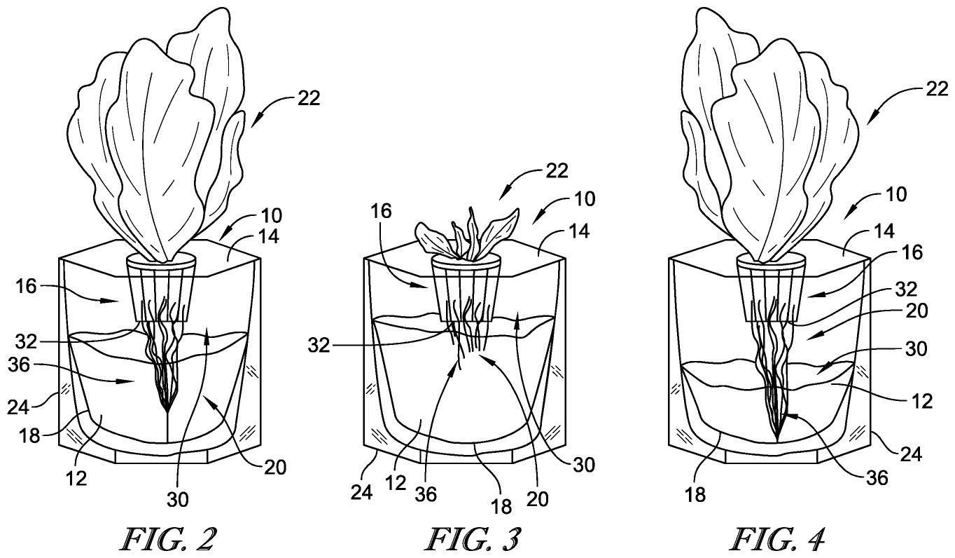

Referring now to FIGS. 2-4, the progression of growth of the below pod portion 20 of the plant 22 is shown relative to the consumption of the growth media 12. In early stage development, shown in FIG. 3, an upper surface 30 of the growth media 12 is positioned to be spaced apart from the bottom 32 of the pod 16 such that a gap is formed there between. The pod 16 includes a growing medium, such as soil, for example, and an immature organism such as a seed, a bulb, a seedling, or cutting. The positioning of the cap 14 is such that the bottom 32 of the pod 16, being above the surface 30 of the growth media 12, creates an air gap. The under pod portion 20 matures from the immature organism into the gap receiving nutrients from the growing medium in the pod 16 gathering moisture, oxygen, and nutrients from inside the chamber 10 through evaporation and uptake by the portion 20. As the plant 22 grows, some of the under pod portion 20 becomes immersed into the growth media 12 as shown in FIG. 2. A portion of the under pod portion 20 is in contact with the air in the space above the surface 30 of the growth media 12 and receives moisture and nutrients through the direct submersion of a portion of the roots 36 into the growth media 12. As the plant 22 fully matures, the growth media 12 continues to recede as shown in FIG. 4. Produce from the plant 22 can be continuously harvested throughout the progression of growth, and once the plant is in a sustained growth condition, continued harvesting of the production from the plant 22 can be sustained with ongoing replacement of growth media 12. It should be understood that when an organism other than a vegetative plant is grown in the chamber 10, such as fungi, mycelium, algae, bacteria, viruses, or the like, the immature organism may be in the form of a spore, or an inoculated substrate that is placed in the pod 16 or mixed directly in with the growth media 12.

One benefit of the use of the single chamber 10 for a singular organism 22 is the ability to gather data relative to the characteristics of the particular organism. It has been determined empirically that the same type of plant or organism may uptake water, air, and nutrients at a uniquely different rate than another plant of the same type. Monitoring of these parameters with sensors allows for the tailored application of the growth inputs to the particular organism to maximize yield. In addition, it should be understood that the size of the chamber 10 may vary based on the particular organism being grown. In some embodiments, the chamber 10 may be adapted to have a different volume, height, width, shape, or even material for the housing 24. In some embodiments, the chamber 10 is formed with housing 24 having a narrower portion and a smaller cap 14. The approach of having a narrower portion of the housing 24 near the top tends to increase water efficiency and reduce evaporation. In still other embodiments, the pod 16 may be positioned in a side wall of the housing 24 which tends to reduce the evaporation of the growth media 12.

As the organism 22 continues to grow and the nutrient solution/growth media 12 is depleted, the chamber 10 is refilled to an appropriate level. The refill level of the media 12 can be any amount as long as it does not exceed the maximum amount that would cover the primary air supplying roots and thereby suffocate the plant 22. It has been found that the ideal level of media 12 is to position the surface 30 between one-half and three-quarters of the total height of the chamber 10. This extends the intervals between interventions needed to maintain growth.

Ideally the height of nutrient solution/growth media 12 being one-half to three-quarters of the total height of the chamber 10 will extend the intervals between intervention or adding additional nutrient solution 12. An amount more or less than on-half to three-quarters of the height of the chamber 10 is acceptable as long as it provides the appropriate amount of nutrient solution 12 to the root system and leaves an adequate space for the air roots to obtain the required air/nutrients mixture. This will vary based upon the shape of the chamber 10, type of plant and the individual specifics of the environment.

The disclosed method and system can be purpose built and manufactured specifically for hydroponic singular chambers 10. In some embodiments, the caps 14 may be be solar to power sensors, reflective to increase photosynthesis, and may comprise an opening or other method for adding additional fluid mixture.

The disclosed method may be implemented by conversion of traditional agricultural receptacles utilizing conversion caps 14, or conversion of any other receptacle capable of holding the solution 12 by use of a conversion cap 14 that rest upon, is attached or affixed or secured by any other means to the traditional agricultural receptacle with a growth pod 16 either being an integral part of the cap 14 or attached, affixed or secured by the cap 14 by any other means.

The disclosed method may also be implemented by converting post-consumer waste or packaging into agricultural receptacles utilizing conversion caps 14, or conversion of any other receptacle capable of holding the hydrating fluid solution 12 by use of a conversion cap 14 that rests upon, is attached or affixed or secured by any other means to the converted receptacle with the growth pod 16 either being an integral part of the cap 14 or attached, affixed or secured by the cap 14 by any other means.

The disclosed method may also be implemented by converting post-consumer waste or packaging into agricultural receptacles by making the receptacle capable of containing hydrating fluid by use of a hydroponic conversion liner, by means of a coating applied to the receptacle or by use of a mixed media capable of holding the solution 12 within a porous receptacle. The converted receptacle may utilize a conversion that rests upon, is attached or affixed or secured by any other means to the converted receptacle with growth pod 16 either being an integral part of the cap 14 or attached, affixed or secured by the cap 14 by any other means.

In any of the converted embodiments, the caps 14 may be solar to power sensors, reflective to increase photosynthesis, and may comprise an opening or other method for adding additional fluid mixture.

The present disclosure comprises a cap 14 that has a singular integrated growth pod 16 or a void (hole) for a growth pod 16 to be placed, rest or affixed and that affixes to the receptacle. The cap 14 rests upon, is attached or affixed or secured by any other means to a chamber 10 with the growth pod 16 either being an integral part of the cap 14 or attached, affixed or secured by the cap 14 by any other means in which a growth pod 16 is suspended and inside a receptacle capable of containing a hydrating solution 12 with nutrients.

Examples of embodiments of post-consumer waste that may be utilized for a chamber 10, or converted to function as a chamber 10 include disposable coffee cups, plastic cups, coffee containers, trash cans, current flower pots (receptacles), buckets, tins, bowls, canning jars with the growth chamber 10 under the screw top lid; the growth pod 16 sized to rest upon the edge and the screw down lid sandwiching the growth pod 16 between the lid and the jar, plastic bottles of all kinds with screw on lids, beverage cans of all kinds with the appropriate sized cap 14 and an offset hole or integrated shaped and sized pod 16 to slide into the hole. These foregoing examples are provided for reference and the list of possible post-consumer materials that may be converted is not exhaustive as there are many other potentially convertible structures not listed here.

In some embodiments, the method may be used to track growth from a seed and data collection at the individual plant level. Internal and external sensors capable of collecting data may be used in the chambers 10. The sensors may be capable of reporting the data either wired or wirelessly. The sensors may stand alone or be connected to a network of other chambers 10. In some embodiments, the sensors may give a visual or auditory indication on the chamber 10 or other location. It is contemplated that the sensors may be solar powered by solar cells on the chamber 10 or caps 14 or standalone external power. Each system and individual component of the system may be tracked individually and as in use together to provide data with granularity and as an exact particular of the each system, each individual plant and cumulative aggregated data both short and long term. Data such as plant type, plant size, usage of resources (such as water), environmental factors (inside the chamber 10 and exterior factors) such as: light received, light temperature, light color spectrum, air temperature external to the chamber 10, air temperature internal to the chamber 10, pH of the solution 12, volume of the solution 12, nutrient parts per million of the solution, usage of each nutrient, the concentration of the nutrients in the solution 12 throughout the entire life cycle of the plant, the yield of plant, and growth rate over time may be tracked and collected.

### PERFORMANCE

The performance of present disclosure can be contrasted with the approach disclosed in U.S. Pat. Nos. 5,385,589 and 5,533,299 to Kratky (“the Kratky method”), which is a well-known passive hydroponic growth approach. The method of the present disclosure, as will be described below, has unexpected superior performance as compared to the Kratky method. Notably, the Kratky method is well-known as being for short-term crops, such as lettuce, and clearly discloses that the structure is designed to simultaneously support multiple plants in a single solution.

By contrast, the present disclosure is directed to a container which houses a single organism. It has been determined that this distinction provides the basis for the superior performance of the method and apparatus of the present disclosure. Namely, the Kratky method is not suitable in long-cycle growth and water usage beyond a single harvest period. It has been discovered that when there are multiple plants that share the same solution, the plants appear to create chemicals that they release into the water which toxifies the water, providing a biological signal to other plants to induce them not to grow to stem competition between the plants. This biological response, in the Kratky method, increases and becomes more concentrated with the amount of time each plant competing and sending chemical signals in an ever increasing rate.

Because the utility and results and underlying operational principles that are work between the present disclosure and the Kratky method are different, determining how to compare and designing the experiments to do the comparison required much work. Testing each against each baseline and the metrics to choose as a baseline/constant to test against are challenging as the Kratky method is only useful with short life fast growth crops (like lettuce and leafy greens) in a permanent and level location, with very strict parameters on temperature, water ranges (pH and PPM), one type crop per planting system and harvesting all of the plants at same time.

In making a comparison, there is difficulty maintaining a continuous harvest in the Kratky method and growth due to the multiple apertures in the Kratky method as each plant (even of same type and seed will grow at different rates having the largest and fastest growing ones consuming the water and nutrient faster than the others leaving them to die due to lack of resources. Alternatively, trying to refill the water so than the smaller slower plants could access the resources would oversaturate the larger and faster growing ones and they would die.

Accuracy in results trying to use multiple types of plants in testing is also limited due to both of the above reasons. Even using leafy greens like bok choy and different types of lettuce led to the death of all lettuces by starvation as the bok choy consumed water faster than the lettuce could keep up and the death of the bok choy when the system was continuously refilled so that lettuce could survive. The water/nutrient solution using the Kratky method, without the aid of intervention and adjusting pH and using an air bubbler could not sustain growth of a continuous harvest method. Due to the multiple apertures in the Kratky method and the chemical exchanges and organic waste produced by multiple plants in reaction to the other plants the water (pH and solids), as well as the tight tolerances required of the temperature ranges, required that the system had to be closely monitor or the plants would be stunted or die before reaching harvestable size. It was also discovered that if there was any angle (as in not completely level) the plants at the lower end of the angle would be able to reach nutrients and survive but the plants at the other end would be stunted and eventually die from not being able to reach the water and nutrients.

To perform testing, interventions on the Kratky method system were required to make it a viable growing option. This required (1) control of the temperature of the water, (2) use only water that was optimal (reverse osmosis, distilled), (3) only place the system where it was completely level or adjust to level, and (4) allocate a space that would not be needed for any other purpose as the weight of water as required in the Kratky method and the tight tolerances that had to be maintained for the plants to survive are not conducive to mobility.

In contrast, the system and method of the present disclosure is suitable for both short growth cycle crops (like lettuce and leafy greens) and long growth cycle plants, including fruiting plant like tomatoes, strawberries, eggplant, and peas. The present disclosure provides a method that works with ever-growing/perennials such as trees, houseplants, and flowers. The continuity of growth and harvest cycles off the same plants doesn't require narrow temperature ranges, and it can grow multiple diverse crops in a very small horizontal footprint, weighing very little and provided for continued growth with ongoing harvesting. The present method also works without requirement for specialized or treated water.

### EXPERIMENTAL RESULTS

Example 1-Superior Growth Head Lettuce Time: 45 Days Temp: 65-75 degrees F. Light Cycles: 12-16 hours a day.

When testing for water usage the highest efficiency obtained using the Kratky method using lettuces and leafy greens over a period of forty-five days after being placed in systems with two apertures and plants with 270 oz. of water or average of 135 oz. per plant for lettuce. Over the same period, the present disclosure systems growing under the same conditions, albeit with two separate chambers 10, used 112 oz. of water or an average of 56 oz. per plant.

As to the production of the harvest by cutting the plant at the base, the Kratky method, which produced a wide difference in size as one grew faster than the other as observed by the root ball being almost double in size of the larger one, produced 7.5 oz. and 11.3 oz. of lettuce. By comparison, the lettuce produced in the present disclosure systems were 13.4 oz. and 14.2 oz., a much closer range in size. The present disclosure provided a yield of 27.6 oz. with 112 oz. of water, while the Kratky method provided an 18.8 oz. yield with 270 oz. of water consumed. This was a 47% increase in yield while only using 41.5% of the water.

Example 2-Superior Growth Head Lettuce Time: 60 Days Temp: 65-75 degrees F. Light Cycles: 12-16 hours a day.

When testing for water usage the highest efficiency obtained using the Kratky method using lettuces and leafy greens over a period of sixty days with two apertures and plants usage of 413 oz. total or 256.5 oz. of water per plant for lettuce. Over the same period, the present disclosure systems growing under the same conditions used 194 oz. or 97 oz. of water per plant.

Under these conditions, the Kratky method produced a 15.3 oz. and 17.9 oz. lettuce yield while the lettuce produced in the present disclosure systems were 24.4 oz. and 26.1 oz. The present disclosure systems reached market weights “small head” (11 oz.), medium (19 oz.), and large (26 oz.) weights much faster than the Kratky method with the present disclosure being above small at forty-five days and the Kratky method only being at medium while the present disclosure was at large at sixty days.

The roots on the present disclosure systems were on average across all crops one-third of, or smaller, than in the Kratky method while producing more foliage and fruits. Thus, it is clear that the present disclosure system encourages growth in the foliage and fruits while minimizing the growth of roots as compared to the Kratky method.

Example 3-Superior Hardiness Head Lettuce and Kale Time: At 37 days plants were frozen solid in the systems. Temp: Below freezing for 3 days degrees. Light Cycles: 12-16 hours a day.

It is well known that the Kratky method requires a very narrow temperature range to grow crops, which is limit of the system and method as much as the plants being grown. During testing in late 2017, an unexpected cold period in Indiana that reached −20° F., some test plants were in an unheated space.

Thirty-eight lettuce plants and twenty-seven kale plants were frozen in the present disclosure systems for three days until placed in a heated area and thawed. All plants survived and continued to grow after being thawed out and harvest was continued for the next ninety days. In comparison, ten heads of lettuce and ten kale plants in two separate ten aperture were in the Kratky method systems for testing. After discovering they were frozen, they were then moved into the same space and same conditions as the present disclosure plants discussed above and all died. Due the constraints of the Kratky method and the large amount of water required to be added all at once this created a much larger mass of ice that did not thaw as quickly as those in the individual the present disclosure systems and the plants did not recover. This unexpected discovery highlighted the advantage of the present disclosure systems and processes of individual apertures in size, mobility and the present disclosure process of growing produced an unexpected result of being able to expand the lower range of growing (cold range) of the temperature scale. Empirical evidence shows that the crops may be continuously grown in the presently disclosed system and method with temperature ranges from lows of freezing to high extremes of 109.7 degrees.

Example 4-Superior Hardiness Head Lettuce(s) Multiple Types, Kale (multiple types), Bok, Choy (multiple types), Snap Peas, Tomatoes (multiple types), Peppers (multiple types), Eggplant (multiple types), Green Beans (multiple types), Basil (multiple types), Arugula, Spinach (multiple types), strawberries. Time: Over 180 Days and still growing. Temp: Variable up to 109.7 F. Light Cycles: 12-16 hours a day.

For a period of testing that exceeds one-hundred-eighty days, and plants continuing to thrive, in a test space that has a daily swing of 87° F. (low) to 109.7° F. every day in 16 hour cycles of increasing heat to maximum and 8 hours of decreasing heat to 87*F. Under these conditions, it has been discovered that that traditional cold and cool plants like lettuce, kale, bok choy, spinach, snap peas, chard (all believed to only be cold or cool weather crops) are thriving and have not died as they have in the Kratky method or bolted as they would in the ground or any other method and the warm weather crops like the tomatoes, peppers and eggplant are beyond their traditional known temperature range growing ability.

This result is unique to this method and allows food growth without expensive infrastructure with rapid deployment in areas where it was thought to be impracticable. This has also shown to be the case in the field tests with users who are growing cold weather crops in the present disclosure systems in Belize and Southern India where the temperatures range from 80-120° F.

It is well known that the Kratky method works for short cycle fast growing plants but is not suitable for long cycle and permaculture. The present disclosure systems excel in long cycle, fruiting plants and trees, herbs, and permaculture and utility in convenience, predictability, sustainability, accessibility and ability to grow a multitude of varieties in a small footprint.

The benefits of the present disclosure method produces yields that exceed the Kratky method faster, and since the plant continues to live in the system with minimal intervention the continued harvest continues to produce superior yields at each subsequent harvest. Examples include: lettuce harvested over three months and combined harvest of 78 oz.; basil harvested over the course of eight months without end of life; tomatoes harvested over three months; strawberries harvested over three months; bok choy harvested over three months; arugula harvested over eight months with continued production; and peppers harvested over a five month period.

It has also been discovered that using the present disclosure systems and methods, each plant can individually be controlled by light cycles, temperature, planting times and nutrient solution as well as isolate any individual for research and disease spread prevention which is not possible with any shared system. This provides for just in time agriculture and nursery usage as plants are alive during and transport and can delay transplant into fields or orchards until appropriate.

Example 5-Long Growth Cycles Dwarf Tomatoes Time: 180 Days Temp: 70-80 Light Cycles: 12-16 hours a day.

The Kratky method system included six plants that began to die after sixty days and produced one-third of the harvest of the present disclosure systems, producing sixteen tomatoes at sixty days as compared to an average of forty-eight tomatoes with the present system. The Kratky system used forty-eight gallons of water at an average of eight gallons per plant while the present disclosure systems used two and one-half gallons per plant at the sixty day point and continued to produce and average of an additional 53 tomatoes per plant over the course of the next three months.

Example 6-Long Growth Cycle Perennial Snake Plant Time: 365+ Days Temp: 70-80 Light Cycles: 4 hours a day.

Snake plant, also known as mother-in-law's tongue, is a houseplant that like dry climate and requires low light. One plant was transplanted in a the Kratky method system with lettuce a short cycle, low water plant and at the same time took another transplant from the same parent plant and put it in an the present disclosure system.

In the Kratky method system with other plants the snake plant is unable to keep up with the other plants and died at twenty-seven days while the one in the present disclosure system in 20 oz. of water at initial fill is still alive after one year and has used less than 8 oz. of water.

Example 7-Superior Hardiness Basil Time: 270 Days Temp: 70-80 Light Cycles: 12-16 hours a day.

A test of basil grown in the Kratky method using a six aperture system used 21.6 gallons (3.6 gallons per plant) of water over sixty-five days. The system was not perfectly level and the two plants at the high end were much smaller than the two in the center and the two on the low end also were smaller. In contrast, the six basil plants grown in the present disclosure systems stayed consistently similar in size and larger than any in the comparative Kratky method plants at the sixty-five day point. In comparison, the plants of the present disclosure used a total of 9 gallons (1.5 gallons per plant) of water over sixty-five days. The basil in the present disclosure systems are still in the same systems and growing and giving after eight months and the only intervention has been refill with water.

Although this disclosure refers to specific embodiments, it will be understood by those skilled in the art that various changes in form and detail may be made without departing from the subject matter set forth in the accompanying claims.

1. A method of growing a vegetative plant, the method comprising the steps of:
positioning an immature portion of a plant in a growth pod,
positioning the growth pod in an aperture of a cap comprising a material that prevents the transmission of light through the cap,
supporting the cap on a housing comprising a material that prevents the transmission of light through the housing,
placing a liquid nutrient solution in the housing, such that the upper surface of the liquid nutrient solution is lower than the lower surface of the growth pod,
subjecting the plant to light,
monitoring the growth of the plant until growth sufficient for harvesting is achieved,
harvesting portions of the plant on an intermittent basis, and
reapplying nutrient solution to provide continuous growth of the plant such that the plant continues to grow and provide multiple yields.

2. The method of claim 1, further comprising adding a liquid impervious liner to the housing prior to placing the liquid nutrient solution in the housing such that the housing supports the liner and the liner retains the liquid nutrient solution.

3. The method of claim 1, wherein the liquid nutrient solution is positioned such that the concentration of the nutrients vary through the depth of the nutrient solution.

4. The method of claim 1, wherein a portion of the root structure of the plant is permitted to grow to be directly submersed in the liquid nutrient solution.

5. The method of claim 1, wherein a portion of the root structure is permitted to grow to extend between the bottom of the growth pod and the top surface of the nutrient solution to be exposed to air within the chamber.

6. The method of claim 1, wherein a portion of the root structure of the plant is exposed to air within the chamber to take oxygen from the air within the chamber.

7. The method of claim 1, wherein a portion of the root structure of the plant is exposed to air within the chamber such that the root structure takes in nutrients that are positioned in the air through evaporation of the solution.

8. The method of claim 1, wherein the plant is subject to light intermittently.

9. The method of claim 1, wherein the plant is subjected to temperatures in excess of 100° Fahrenheit for extended periods.

10. The method of claim 1, wherein the growing conditions of the plant are monitored.

11. The method of claim 1, wherein the growing conditions are varied to account for the type of plant.

12. The method of claim 1, wherein the concentration of nutrients is controlled by nutrient retention beads positioned in the chamber.

13. The method of claim 1, wherein the plant is a fruit-bearing plant.

14. A chamber for growing an organism, the chamber comprising
an opaque housing,
a cap supported on the housing, the cap having an aperture defined therein,
a growth pod supported from the cap, the growth pod configured to support a growing organism, and
a liquid nutrient solution positioned in the housing, the liquid nutrient solution having an upper surface that is lower than the lower surface of the growth pod.

15. The chamber of claim 14, wherein the nutrient solution includes nutrient densities that vary through the depth of the nutrient solution.

16. The chamber of claim 14, wherein a portion of the organism extends between the bottom of the pod and the top surface of the nutrient solution to be exposed to air within the chamber.

17. The chamber of claim 14, wherein a portion of the organism extends between the bottom of the pod and the top surface of the nutrient solution to be exposed to air within the chamber and wherein a portion of the organism that is exposed to air within the chamber up takes oxygen from the air within the chamber.

18. The chamber of claim 14, wherein a portion of the organism extends between the bottom of the pod and the top surface of the nutrient solution to be exposed to air within the chamber and wherein a portion of the organism that is exposed to air within the chamber up takes nutrients through evaporation of the solution.
